(19) United States
(12) Patent Application Publication
(10) Pub. No.: US 2005/0181141 A1
(43) Pub. Date: Aug. 18, 2005

(54) Laser-induced explosive vaporization coating method, associated system, and device made by the method

(76) Inventor: Aiden Flanagan, Kilcolgan (IE)

Correspondence Address: KENYON & KENYON, ONE BROADWAY, NEW YORK, NY, 10004, US

(21) Appl. No.: 10/782,073

(22) Filed: Feb. 18, 2004

(51) Int. Cl. B05D 3/00; H05B 6/02

(52) U.S. Cl. 427/421.1; 427/532; 427/591; 427/585; 427/240; 623/1.15

(57) ABSTRACT

A method is provided for coating at least a portion of at least one device that includes arranging on a surface of a substrate a solution, directing a beam at the substrate, and arranging the at least one device in an ejection cone formed by a vaporization of the solution. The beam heats the substrate. The solution may be vaporized by a heat transfer from the substrate to the solution. The ejection cone may include a vaporized solution or an atomized solution. The atomized solution may be formed by an explosive vaporization of the solution. The solvent may have a boiling point less than a thermal damage temperature of the bioactive agent. The method may further include arranging on the solution another solution and ejecting by the vaporization of the solution at least a portion of the other solution into the ejection cone. A system for coating at least one device is provided that includes a target assembly adapted to hold a substrate, a beam source directed at the surface of the substrate and adapted to emit a beam, and an arrangement adapted to hold the at least one device in an ejection cone. A solution may be arranged on a surface of the substrate. A medical appliance is provided that has a coating applied by the method.

### FIELD OF THE INVENTION

The present invention relates to coating methods. More particularly, the present invention relates to a device and method for coating a device using a laser to evaporate a coating to be deposited on the device.

### BACKGROUND INFORMATION

Medical devices may be coated so that the surfaces of such devices have desired properties or effects. For example, it may be useful to coat medical devices to provide for the localized delivery of therapeutic agents to target locations within the body, such as to treat localized disease (e.g., heart disease) or occluded body lumens. Localized drug delivery may avoid some of the problems of systemic drug administration, which may be accompanied by unwanted effects on parts of the body which are not to be treated. Additionally, treatment of the afflicted part of the body may require a high concentration of therapeutic agent that may not be achievable by systemic administration. Localized drug delivery may be achieved, for example, by coating balloon catheters, stents and the like with the therapeutic agent to be locally delivered. The coating on medical devices may provide for controlled release, which may include long-term or sustained release, of a bioactive material.

Aside from facilitating localized drug delivery, medical devices may be coated with materials to provide beneficial surface properties. For example, medical devices are often coated with radiopaque materials to allow for fluoroscopic visualization during placement in the body. It is also useful to coat certain devices to achieve enhanced biocompatibility and to improve surface properties such as lubriciousness.

Coatings have been applied to medical devices by processes such as dipping, spraying, vapor deposition, plasma polymerization, and electrodeposition. Although these processes have been used to produce satisfactory coatings, they have numerous, associated potential drawbacks. For example, it may be difficult to achieve coatings of uniform thicknesses, both on individual parts and on batches of parts. Further, many conventional processes require multiple coating steps or stages for the application of a second coating material, or to allow for drying between coating steps or after the final coating step.

Conventional methods of coating stents or devices with a drug-polymer layer, such as spraying or dipping, may require a solution of the drug-polymer to physically wet the surface of the stent. Spraying or dipping may cause uneven and unpredictable wetting, and distribution and evaporation of the solvent molecules may result in a non-uniform coating. A non-uniform coating may lead to the unit failing Kinetic Drug Release, drug uniformity and coating thickness specifications.

There is, therefore, a need for a cost-effective method of coating devices that results in uniform, defect-free coatings and uniform drug doses per unit device. The method would allow for a multiple stage coating in order to apply a bioactive material that may be environmentally sensitive, e.g., due to heat and light (including ultra-violet) exposure. Multiple stage coating may also be used to prevent degradation of the bioactive material due to process-related forces (e.g., shear). The method would thus allow for better control of the sensitivity of the bioactive material and reduce any potential degradation due to environmental issues. The method would also reduce variations in the coating properties.

Current coating techniques may result in thicker coatings, resulting in excess bioactive ingredient being deposited on the medical device. Excessive bioactive ingredient delivered to the lumen may be toxic. Thinner coatings may allow more precise deposition of bioactive ingredient(s) on the medical appliance, and may allow greater precision in the delivery of the bioactive agent. Therefore, an efficient method of applying thin coats of materials to medical appliances is desired.

One technique used to provide thin coating is the MAPLE technique. “The deposition, structure, pattern deposition, and activity of biomaterial thin-films by matrix-assisted pulsed-laser evaporation (MAPLE) and MAPLE direct write,” in Thin Solid Films (volumes 398-399, November 2001, pages 607-614), discusses the MAPLE process and is incorporated herein by reference.

Devices may be coated by a gas assisted spraying process. A polymer/drug combination may be dissolved in a solvent mixture. The solution may be sprayed onto the devices and a polymer/drug film may be formed when the solvents evaporate. The ability to apply thin coatings on products may be limited by the capabilities of a gas assisted spraying process. A gas assisted spraying process may have a high variability for thin coatings.

There thus is a need for a method of coating a device that is accurate and allows a high degree of control over the thickness of the coating.

### SUMMARY

According to an exemplary embodiment of the present invention, a surface may be coated with a film of polymer and/or drug using a laser based evaporation and deposition process that allows accurate control over the coating thickness and quality without thermal damage to the drug or polymer. The surface may be a device, stent, or medical device onto which a therapeutic drug is coated in a polymer matrix. A laser may be used to create a short duration heat flux from an absorbing solid surface to a solution. The heat flux may cause an explosive vaporization and dispersion of the surrounding liquid.

A method is provided for coating at least a portion of at least one device that includes arranging on a surface of a substrate a solution, directing a beam at the substrate, and arranging the at least one device in an ejection cone formed by a vaporization of the solution. The beam heats the substrate. The solution may be vaporized by a heat transfer from the substrate to the solution. The ejection cone may include a vaporized solution or an atomized solution. The atomized solution may be formed by an explosive vaporization of the solution. The solution may include a bioactive agent dissolved in a solvent. The solvent may have a boiling point less than a thermal damage temperature of the bioactive agent. The method may further include ejecting by a vaporization of the solution at least a portion of the bioactive agent into the ejection cone. The bioactive agent may include a drug and/or a polymer.

The method may further include, after the directing of the beam operation, directing a gas flow to transport the bioactive agent to the at least one device. The method may further include enclosing the substrate and the at least one device in an enclosure and removing by a pump the solvent in the vaporized solution from the enclosure. The enclosure may be maintained at a partial vacuum. The arranging of the solution may be by spraying or spin coating. The solution may absorb about zero energy of the beam. The substrate may be flat, concave, or convex. The beam may be a laser beam, an electron beam, or a light beam produced by a flashlamp. The beam may be pulsed. The method may further include moving the beam or the substrate with respect to the other of the beam and the substrate. The at least one device may include a medical appliance and/or a stent.

The method may further include arranging on the solution another solution and ejecting by the vaporization of the solution at least a portion of the other solution into the ejection cone. The other solution may include a bioactive agent dissolved in a solvent. The arranging of other solution may be by spraying or spin coating. The other solution may absorb about zero energy of the beam. The solvent of the other solution may have a higher boiling point than a boiling point of the solution and the boiling point of the solution may be less than a thermal damage temperature of the bioactive agent. The bioactive agent may include a drug and/or a polymer.

A system for coating at least one device is provided that includes a target assembly adapted to hold a substrate, a beam source directed at the surface of the substrate and adapted to emit a beam, and an arrangement adapted to hold the at least one device in an ejection cone. A solution may be arranged on a surface of the substrate. An apex of the ejection cone may be at a target point that the beam contacts the surface. A vaporized agent may be formed from the solution being vaporized by a heat transfer from the substrate to the solution. An atomized agent may be formed by an explosive vaporization of the solution. The gas source may be adapted to transport the vaporized agent or the atomized agent from the surface to the at least one device. The system may further include an evaporation chamber adapted to enclose at least the substrate and the at least one device. The system may further include a pump adapted to remove a solvent from the evaporation chamber. The pump may form a partial vacuum in the evaporation chamber. The beam source may include a laser, an electron beam source, or a flashlamp. The solution may include a drug and/or a polymer. The at least one device may include at least one medical appliance. The target assembly or the beam source may be adapted to move with respect to the other of the target assembly and the beam source. The target assembly may be adapted to spin. A spinning of the target assembly may cause the solution to spread on the surface. The system may further include an arrangement for spraying the solution on the surface of the substrate.

A medical appliance is provided that has a coating applied by the method. The medical appliance may include a stent. The coating may include a masking material. The coating may be chosen from a group consisting of a polymer with a suspended drug, a non-thrombogenic agent, a lubricious material, a non-slippery material, a radioactive agent, and a magnetic signature. The coating may be a radiopaque agent.

### BRIEF DESCRIPTION OF THE DRAWINGS

FIG. 1 illustrates schematically an exemplary embodiment of a system using an exemplary method according to the present invention to coat a stent.

FIG. 2 illustrates an exemplary method of the present invention showing an ejection cone and a device.

FIG. 3 is an enlarged view of an exemplary interface between a substrate and an overlying solution according to an exemplary method of the present invention.

FIG. 4 illustrates schematically an alternative exemplary embodiment of a system using an exemplary method according to the present invention and including a substrate with two solutions.

FIG. 5 is an enlarged view of an exemplary interface between a substrate and two overlying solutions according to an exemplary method of the present invention.

FIG. 6 is a flowchart illustrating an exemplary method according to the present invention.

### DETAILED DESCRIPTION

According to an exemplary embodiment of the present invention, a polymer and drug may be dissolved in a solvent and poured onto a flat surface of a substrate (also known herein as a source substrate) to form a thin liquid coat. A pulse of laser radiation may be created to illuminate a portion of the surface of the substrate. The laser may rapidly heat the surface of the illuminated substrate. The liquid layer that may be in contact with the surface may be instantly vaporized due to heat conduction from the heated substrate surface. The vaporized layer may expand outwards from the source substrate and may cause a localized, outward explosion of the liquid on top of the vaporized layer. The liquid on top of the vaporized liquid may be ejected by the force of the explosive evaporation.

The ejected liquid may be atomized by the outward explosion of vapor and may travel towards a target stent onto which the atomized liquid may deposit. The laser parameters and the thickness of the liquid coat on the substrate may enable accurate control the amount of liquid ejected and atomized. A polymer/drug film may be formed on the stent when the solvent evaporates from the deposited film.

The process may avoid thermal degradation of the drug/polymer by using a solvent that has a boiling point temperature less than the thermal damage temperature of the drug/polymer. Additionally, a partial vacuum may be used to lower the boiling point of the liquid. The polymer/drug solution may have a high transmittance for the laser wavelength, i.e., the laser wavelength may only be fractionally absorbed by the solution and therefore there may be negligible direct heating of the polymer/drug solution by the laser. The preferred laser wavelength may be in the infrared region of the electromagnetic spectrum (e.g., 0.7 to 5 micrometers), for example ND:YAG (1.06 micrometers) or CO₂ (10.6 micrometers).

The laser parameters may be chosen so that the laser intensity absorbed at the substrate surface is sufficient to create a heat flux into the liquid greater than the critical heat flux of the fluid. This condition may create an explosive vapor expansion. A laser may be used because it can create the high heat flux in a short duration (<1 sec; typically <100 milliseconds) in a small area (<1 mm).

The thickness of the film may be important to the deposition process. The film may be created by spraying the substrate surface with the solution. Alternatively, the solution may be spin coated on the substrate to create an even solution film. The thickness may be monitored accurately using an optical or other method.

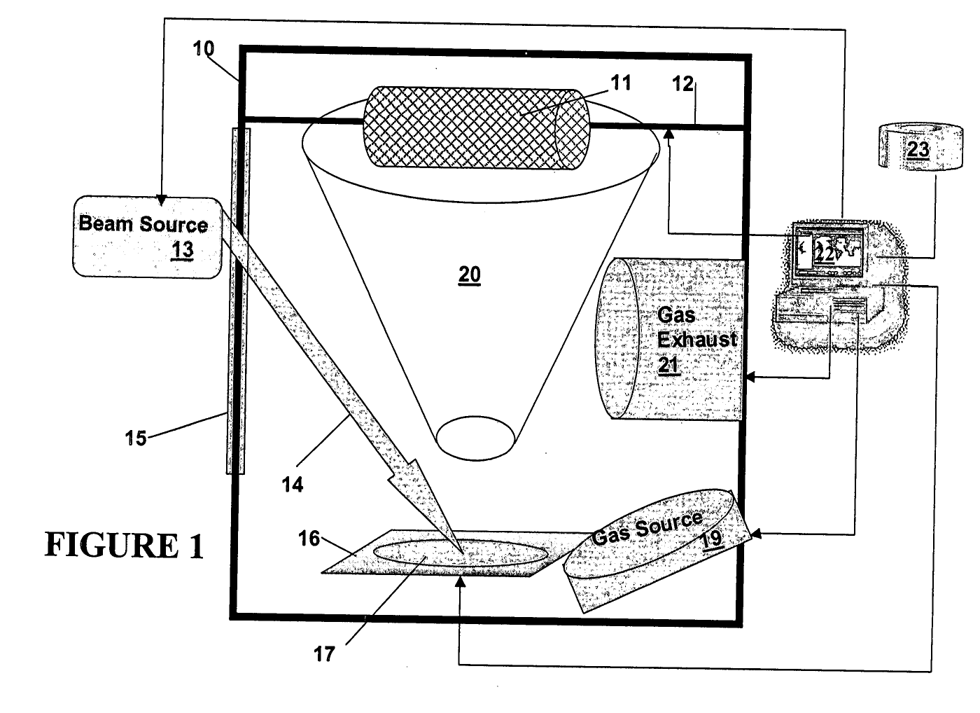

FIG. 1 includes evaporation chamber 10 enclosing device 11 arranged on holder 12. Holder 12 may be adapted to move device 11 laterally, longitudinally, vertically, and/or rotatably. Holder 12 may also be adapted to hold more than one device, and may be adapted to move device 11 out of evaporation chamber 10 and move another device 11 into evaporation chamber 10. Holder 12 may be adapted to continuously move device 11 and replace it with a new device 11 in order to coat device 11 in a continuous fashion rather than in a batch coating process.

Beam source 13 is situated outside evaporation chamber 10 in such a manner that it projects beam 14 through window 15 of evaporation chamber 10. Alternatively, beam source 13 may be situated inside evaporation chamber 10, and evaporation chamber 10 may or may not have window 15. Beam source 13 may be any type of source emitting a beam and/or a pulse of any appropriate frequency or energy. Beam 14 may possibly be a beam of ultraviolet (UV) light, infrared (1R) light, or an electron beam.

Beam 14 may impinge on substrate 16, which may have solution 17, which may be a drug and/or polymer, arranged on a surface of substrate 16. The drug and polymer combination in solution 17 on substrate 16 may be a therapeutic and/or bioactive agent useful for any number of purposes. Some of the possibilities for therapeutics and/or bioactive agents coated on a medical appliance are discussed below. When beam 14 impinges on substrate 16, beam 14 may impart energy to the molecules in substrate 16, thereby heating substrate 16. The heat from substrate 16 may transfer by conduction to solution 17 and may vaporize the solute, drug, and/or polymer of solution 17. The solvent in solution 17 may have a lower boiling point than the drug and/or polymer, and may have a boiling point less than a thermal damage temperature of the drug and/or polymer. Therefore, the heat transferred by conduction from substrate 16 may vaporize the solvent before any damage occurs to the drug and/or polymer. The solvent may explosively evaporate causing other portions of solution 17 (and in particular the drug and/or polymer) to eject from the surface of substrate 16 and may form ejection cone 20. Ejection cone 20 may include molecules of solvent, drug, and/or polymer moving with some velocity from substrate 16 towards device 11. The velocity of the molecules in ejection cone 20 may be provided solely by the vaporization of solution 17 on substrate 16 in a vacuum provided by evaporation chamber 10.

Additionally, there may be a pressure differential assisting the movement of molecules in ejection cone 20 which may be created by positioning a pump near the top of evaporation chamber 10 (for instance, gas exhaust 21). Alternatively, gas source 19 may be utilized to assist the movement, and/or increase the velocity, of molecules of solute, drug, and/or polymer moving from substrate 16 towards device 11. Gas source 19 may provide a flow of an inert gas and/or a material that will not interfere with the drug, bioactive agent, and/or polymer being deposited on device 11.

Additionally and alternatively, beam source 13 may redirect beam 14 to cause laser beam 14 to impinge on new areas of substrate 16. Additionally and alternatively, window 15 may operate to focus and redirect beam 14. Additionally and alternatively, substrate 16 may move with respect to beam 14.

The molecules of solute, drug, and/or polymer moving from substrate 16 towards device 11 may deposit on device 11 in a molecule-by-molecule manner. The deposition of molecules may therefore be very controlled and may enable very thin layers to be deposited on device 11. The solute in the vapor may deposit on device 11, but may subsequently evaporate again into evaporation chamber 10. Evaporated solute may be removed from evaporation chamber 10 by gas exhaust 21 (which may be an air pump). Gas exhaust 21 may enable evaporation chamber 10 to operate continuously in a vacuum or partial vacuum state, thereby promoting the evaporation of any deposited liquid solute from device 11 or elsewhere in evaporation chamber 10.

Processor 22 may control any or all of holder 12, beam source 13, substrate 16, gas source 19, and gas exhaust 21. Processor 22 may be electrically coupled to memory 23, which may include process parameters for coating various types and numbers of devices with various types of drugs and bioactive agents in various thicknesses.

Alternative exemplary embodiments may provide for additional beam sources and/or additional targets for the deposition of multiple layers of different materials. Additionally, it may be possible to coat just a portion of device 11, for instance, the ends of device 11, by appropriate positioning or moving of device 11 in ejection cone 20. Additionally and alternatively, masks and/or other barriers may be utilized to promote the coating of a portion of device 11, while maintaining another portion of device 11 free of coating.

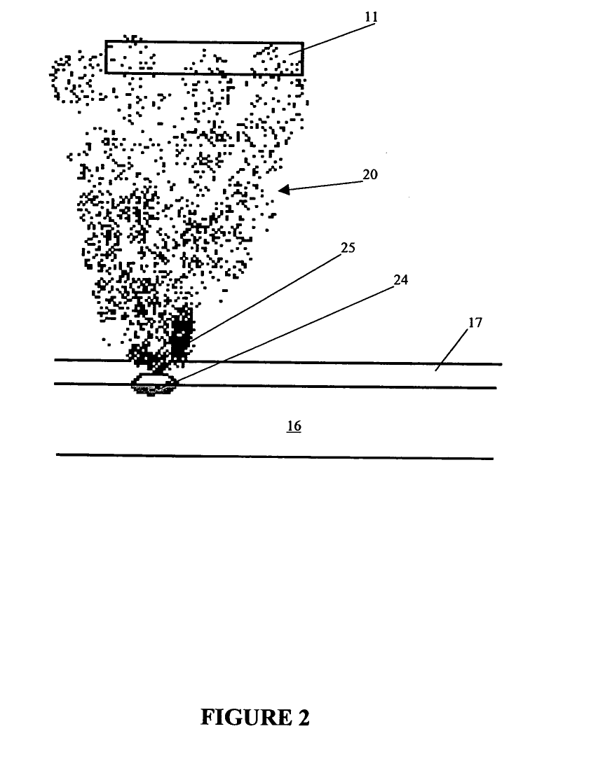

FIG. 2 illustrates an exemplary method of the present invention showing ejection cone 20 and device 11. Substrate 16 is shown in cross-sectional perspective with solution 17 forming a layer on the surface of substrate 16. Heated zone 24 of substrate 16 is created by a beam being projected or pulsed onto substrate 16 through solution 17. Heated zone 24 heats conductively a portion of solution 17 that is on top of heated zone 24, causing the vaporization of a portion of solution 17. The vaporization of solution 17 may be explosive and may cause the atomization of a portion of solution 17 overlying the vaporized portion of solution 17. Atomized material 25 may be ejected into ejection cone 20. Device 11 may be arranged in ejection cone 20 and thereby be coated with material from solution 17. Solution 17 may include a solvent and a drug and/or polymer dissolved in the solvent. When atomized material 25 coats device 11, the solvent in atomized material 25 may evaporate, leaving the drug and/or polymer coating device 11.

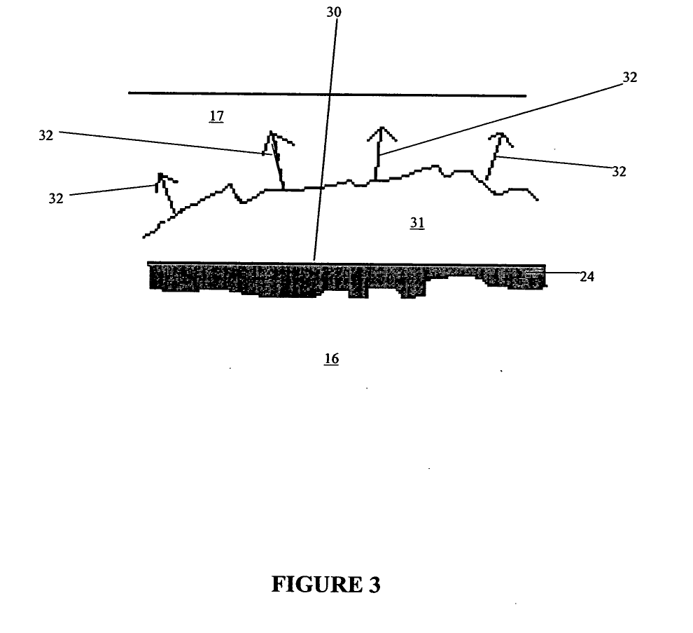

FIG. 3 is an enlarged view of an exemplary interface between substrate 16 and solution 17 overlying substrate 16 according to an exemplary method of the present invention. Substrate 16 includes heated zone 24 near surface 30 of substrate 16. Within solution 17 and adjacent to heated zone 24 is vaporized solvent 31. Vaporized solvent 31 is a portion of solution 17 which has been vaporized due to a conductive heat transfer at surface 30. The conductive heat transfer causes the temperature of solution 17 to reach the boiling point of a solvent that is a constituent of solution 17. When the solvent of solution 17 boils, changing state from liquid to gas, it becomes vaporized solvent 31. Vaporized solvent 31, along with the other constituents of solution 17, which may remain in a liquid state or may be in any other state, occupies more space than the original solution 17 from which it is formed. The expansion caused by the creation of vaporized solvent 31 may be explosive and may cause an outward force on the remaining portions of solution 17, especially those portions of solution 17 that lie over vaporized solvent 31. Forces 32 may therefore be exerted by vaporized solvent 31 on solution 17. Forces 32 may cause solution 17 to become atomized due to the explosive nature of the vaporization of the solution 17. Atomized solution 17 may be forced upward and outward and broken up into small droplets that may be easily transported in air.

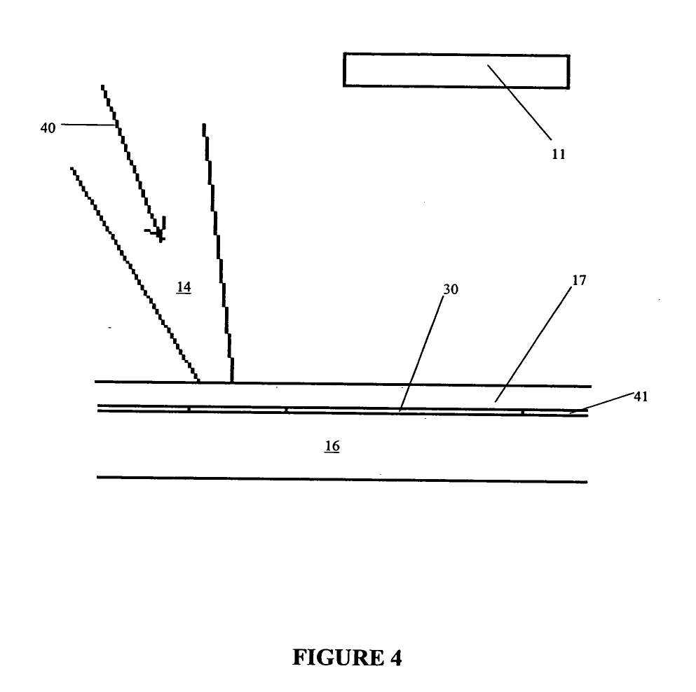

FIG. 4 illustrates schematically an alternative exemplary embodiment of a system using an exemplary method according to the present invention used to coat device 11 and including substrate 16, solution 17, and second solution 41. Beam 14 is directed in direction 40 at substrate 16. Substrate 16 has second solution 41 arranged on surface 30 of substrate 16. Solution 17 is arranged on top of second solution 41. Both of solution 17 and second solution 41 may have a high transmittance with respect to beam 41. Therefore, beam 14 may pass through both solution 17 and second solution 41 with little or no loss of energy. Beam 14 may impinge on surface 30 of substrate 16 and may be absorbed by substrate 16, causing substrate 16 to heat up. Solution 17 may include a drug and/or polymer dissolved in a first solvent. Second solution 41 may include a second solvent having a boiling point lower than the boiling point of the first solvent and lower than a threshold damage temperature of the drug and/or polymer. Therefore, the heating of second solution 16 by conductive heat transfer from surface 30 of substrate 16 may result in the vaporization of second solution 41 prior to the vaporization of the solvent in solution 17. The vaporization of second solution 41 may cause an explosive outward force similar that described above with respect to FIGS. 2 and 3.

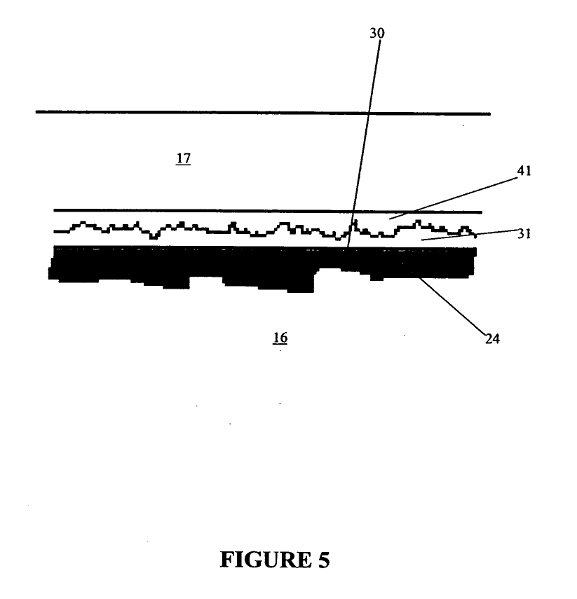

FIG. 5 is an enlarged view of an exemplary interface between substrate 16 and two overlying solutions (solution 17 and second solution 41) according to an exemplary method of the present invention. Substrate 16 includes heated zone 24, which has been heated by a beam of energy. Heated zone 24 heats conductively second solution 41 which is arranged on surface 30 of substrate 16. Above second solution 41 is arranged solution 17. Solution 17 may include a drug and/or polymer dissolved in a first solvent. Second solution 41 may include a second solvent having a boiling point lower than the boiling point of the first solvent and lower than a threshold damage temperature of the drug and/or polymer. Therefore, the heating of second solution 16 by conductive heat transfer from surface 30 of substrate 16 may result in the vaporization of second solution 41 prior to the vaporization of the solvent in solution 17. The vaporization of second solution 41 may create vaporized solvent 31 from the second solvent from second solution 41. The explosive vaporization and expansion of the second solvent of second solution 41 may cause an outward force that may cause solution 17 to be atomized. The atomization of solution 17 may allow the small droplets of solution 17 to be suspended in air and to be propelled towards a device to coat the device. After coating the device, the solvent in solution 17 may evaporate, leaving behind the drug and/or polymer as a thin coating.

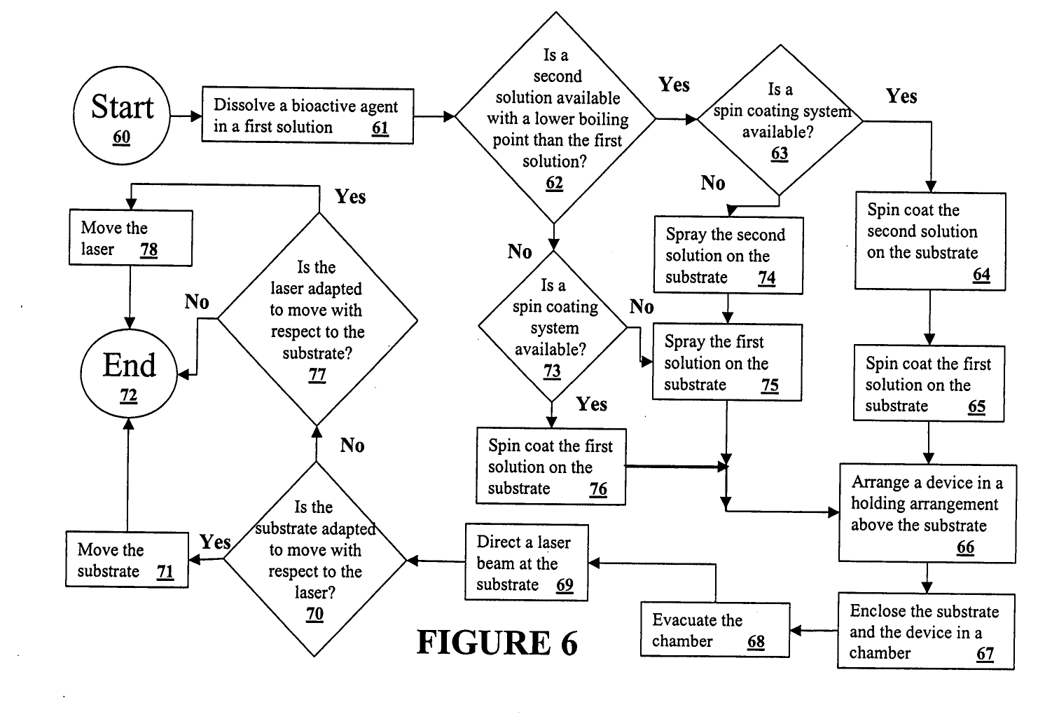

FIG. 6 is a flowchart illustrating an exemplary method according to the present invention. The flow begins in start circle 60 and proceeds to action 61, which indicates to dissolve a bioactive agent in a first solution. From action 61 the flow proceeds to question 62, which ask whether a second solution is available with a lower boiling point than the first solution. If the answer to question 62 is affirmative, the flow proceeds to question 63, which asks whether a spin coating system is available. If the answer to question 63 is affirmative, the flow proceeds to action 64, which indicates to spin coat the second solution on the substrate. From action 64 the flow proceeds to action 65, which indicates to spin coat the first solution on the substrate. From action 65 the flow proceeds to action 66, which indicates to arrange a device in a holding arrangement above the substrate. From action 66 the flow proceeds to action 67, which indicates to enclose the substrate and the device in a chamber. From action 67 the flow proceeds to action 68, which indicates to evacuate the chamber. From action 68 the flow proceeds to action 69, which indicates to direct a laser beam at the substrate. From action 69 the flow proceeds to question 70, which asks whether the substrate is adapted to move with respect to the laser. If the answer to question 70 is affirmative, the flow proceeds to action 71, which indicates to move the substrate. From action 71 the flow proceeds to end circle 72.

If the response to question 62 is negative, the flow proceeds to question 73, which asks whether a spin coating system is available. If the answer to question 73 is affirmative, the flow proceeds to action 76, which indicates to spin coat the first solution on the substrate. From action 76 the flow proceeds to action 66. If the response to question 63 is negative, the flow proceeds to action 74, which indicates to spray the second solution on the substrate. From action 74 the flow proceeds to action 75, which indicates to spray the first solution on the substrate. From action 75 the flow proceeds to action 66. If the response to question 73 is negative, the flow proceeds to action 75. If the response to question 70 is negative, the flow proceeds to question 77, which asks whether the laser is adapted to move with respect to the substrate. If the response to question 77 is affirmative, the flow proceeds to action 78, which indicates to move the laser. From action 78 the flow proceeds to end circle 72. If the response to question 77 if negative the flow proceeds to end circle 72.

Alternatively, an additional solvent (solvent B) with a low boiling point temperature may be added to the solution. Solvent B may be vaporized by the laser heating to create the surface explosion. Solvent B may also be immiscible with the drug/polymer solution. In this situation, solvent B may be coated on the source substrate as a first layer and the drug/polymer solution may form a second layer on top of solvent B. Upon laser heating of the source substrate, solvent B may vaporize due to a critical heat flux and atomize the drug/polymer solution due to an explosive evaporation. Solvent B may be chosen with a very low boiling point. This method may be advantageous if the drug/polymer solvent has a boiling point close to the damage threshold of the drug/polymer.

Both solvents may have a high transmittance with respect to the energy from the beam. In this situation, the solutions may not be heated locally to a higher temperature and damage to the bioactive agent may be avoided.

The substrate that absorbs the laser may have various shapes, including planar, convex, or concave shapes. The shape of the substrate may be chosen to improve the shape of the plume and to ensure that the atomized plume travels in a desired direction. The solution or solutions may be distributed on the surface by spraying, spin coating, or by any other appropriate method. Spin coating may entail putting a drop or other quantity of the solution in a central area of the substrate and then spinning the substrate to cause the solution to disperse over the surface of the substrate.

Lasers may be advantageously utilized since they may be focussed easily. Alternative heat sources may be used such as an electron beam or a flashlamp. Flashlamps may be focussable. A xenon flashlamp may provide a broadband source in the form of a high-powered white light. Lasers may allow a very specific wavelength to be chosen, thereby avoiding damage to the bioactive agent by careful selection of the wavelength.

A drug polymer solution may be prepared by dissolving an appropriate amount of drug and polymer in a solvent. A laser pulse of specific wavelength may be directed at the substrate. The substrate may absorb the laser pulse and heat the solute molecules by conduction from the substrate.

The explosive evaporation of the low boiling temperature solvent may generate a forward directed ejection cone (also known as a vapor cone) containing the evaporated material and/or atomized solution. When a device (for instance, a stent) is placed in the path of the ejection cone, it may be uniformly coated with a drug-polymer film while the volatile solvent molecules may be removed by the chamber's vacuum pump.

Optimization of control factors such as drug solution concentrations, temperature conditions, laser wavelength and distance from the substrate to the stent substrate may allow for coating devices and/or medical appliances with a film of predetermined concentration and thickness.

This technique may allow for the control of the stent coating thickness on a molecular layer-by-layer scale. This control may not compromise the enhanced film adhesion to the medical appliance.

The exemplary technique may also be used to coat a device with more than one drug-polymer film. Once one coating has been deposited onto the device another substrate with another drug-polymer solution dispersed on the surface may be mounted in the laser path and may be used to deposit a new drug-polymer coat over the first. As the solvent has been evaporated before reaching the surface, there may be no medium for mixing between the two distinct layers, thus giving a layer discrete layer interface.

There may be excellent material efficiency using this method, since the drug-polymer solution may be deposited on the medical appliance on a molecular scale. As there is a discreet amount, and not an excess, of material in the ejection cone emanating from the substrate, large losses of unused material removed in the exhaust stream from the evaporation chamber may be avoided.

Medical implants are used for innumerable medical purposes, including the reinforcement of recently re-enlarged lumens, the replacement of ruptured vessels, and the treatment of disease such as vascular disease by local pharmacotherapy, i.e., delivering therapeutic drug doses to target tissues while minimizing systemic side effects. Such localized delivery of therapeutic agents has been proposed or achieved using medical implants which both support a lumen within a patient's body and place appropriate coatings containing absorbable therapeutic agents at the implant location. Examples of such medical devices include catheters, guide wires, balloons, filters (e.g., vena cava filters), stents, stent grafts, vascular grafts, intraluminal paving systems, implants and other devices used in connection with drug-loaded polymer coatings. Such medical devices are implanted or otherwise utilized in body lumina and organs such as the coronary vasculature, esophagus, trachea, colon, biliary tract, urinary tract, prostate, brain, and the like.

The therapeutic agent may be any pharmaceutically acceptable agent such as a non-genetic therapeutic agent, a biomolecule, a small molecule, or cells.

Exemplary non-genetic therapeutic agents include anti-thrombogenic agents such heparin, heparin derivatives, prostaglandin (including micellar prostaglandin E1), urokinase, and PPack (dextrophenylalanine proline arginine chloromethylketone); anti-proliferative agents such as enoxaprin, angiopeptin, sirolimus (rapamycin), tacrolimus, everolimus, monoclonal antibodies capable of blocking smooth muscle cell proliferation, hirudin, and acetylsalicylic acid; anti-inflammatory agents such as dexamethasone, rosiglitazone, prednisolone, corticosterone, budesonide, estrogen, estrodiol, sulfasalazine, acetylsalicylic acid, mycophenolic acid, and mesalamine; anti-neoplastic/anti-proliferative/anti-mitotic agents such as paclitaxel, cladribine, 5-fluorouracil, methotrexate, doxorubicin, daunorubicin, cyclosporine, cisplatin, vinblastine, vincristine, epothilones, endostatin, trapidil, and angiostatin; anti-cancer agents such as antisense inhibitors of c-myc oncogene; anti-microbial agents such as triclosan, cephalosporins, aminoglycosides, nitrofurantoin, silver ions, compounds, or salts; biofilm synthesis inhibitors such as non-steroidal anti-inflammatory agents and chelating agents such as ethylenediaminetetraacetic acid, O,O′-bis (2-aminoethyl)ethyleneglycol-N,N,N′,N′-tetraacetic acid and mixtures thereof; antibiotics such as gentamycin, rifampin, minocyclin, and ciprofoixacin; antibodies including chimeric antibodies and antibody fragments; anesthetic agents such as lidocaine, bupivacaine, and ropivacaine; nitric oxide; nitric-oxide (NO) donors such as lisidomine, molsidomine, L-arginine, NO-carbohydrate adducts, polymeric or oligomeric NO adducts; anti-coagulants such as D-Phe-Pro-Arg chloromethyl ketone, an RGD peptide-containing compound, heparin, antithrombin compounds, platelet receptor antagonists, anti-thrombin antibodies, anti-platelet receptor antibodies, enoxaparin, hirudin, Warafin sodium, Dicumarol, aspirin, prostaglandin inhibitors, platelet inhibitors and tick antiplatelet factors; vascular cell growth promotors such as growth factors, transcriptional activators, and translational promotors; vascular cell growth inhibitors such as growth factor inhibitors, growth factor receptor antagonists, transcriptional repressors, translational repressors, replication inhibitors, inhibitory antibodies, antibodies directed against growth factors, bifunctional molecules consisting of a growth factor and a cytotoxin, bifunctional molecules consisting of an antibody and a cytotoxin; cholesterol-lowering agents; vasodilating agents; agents which interfere with endogeneus vascoactive mechanisms; and any combinations and prodrugs of the above.

Exemplary biomolecules include peptides, polypeptides and proteins; oligonucleotides; nucleic acids such as double or single stranded DNA (including naked and cDNA), RNA, antisense nucleic acids such as antisense DNA and RNA, small interfering RNA (siRNA), and ribozymes; genes; carbohydrates; angiogenic factors including growth factors; cell cycle inhibitors; and anti-restenosis agents. Nucleic acids may be incorporated into delivery systems such as, for example, vectors (including viral vectors), plasmids or liposomes.

Non-limiting examples of proteins include monocyte chemoattractant proteins (“MCP-1) and bone morphogenic proteins (“BMP's”), such as, for example, BMP-2, BMP-3, BMP-4, BMP-5, BMP-6 (Vgr-1), BMP-7 (OP-1), BMP-8, BMP-9, BMP-10, BMP-1, BMP-12, BMP-13, BMP-14, BMP-15. Preferred BMPS are any of BMP-2, BMP-3, BMP-4, BMP-5, BMP-6, and BMP-7. These BMPs can be provided as homdimers, heterodimers, or combinations thereof, alone or together with other molecules. Alternatively, or in addition, molecules capable of inducing an upstream or downstream effect of a BMP can be provided. Such molecules include any of the “hedghog” proteins, or the DNA's encoding them. Non-limiting examples of genes include survival genes that protect against cell death, such as anti-apoptotic Bcl-2 family factors and Akt kinase and combinations thereof. Non-limiting examples of angiogenic factors include acidic and basic fibroblast growth factors, vascular endothelial growth factor, epidermal growth factor, transforming growth factor α and β, platelet-derived endothelial growth factor, platelet-derived growth factor, tumor necrosis factor α, hepatocyte growth factor, and insulin like growth factor. A non-limiting example of a cell cycle inhibitor is a cathespin D (CD) inhibitor. Non-limiting examples of anti-restenosis agents include p15, p16, p18, p19, p21, p27, p53, p57, Rb, nFkB and E2F decoys, thymidine kinase (“TK”) and combinations thereof and other agents useful for interfering with cell proliferation.

Exemplary small molecules include hormones, nucleotides, amino acids, sugars, and lipids and compounds have a molecular weight of less than 100 kD.

Exemplary cells include stem cells, progenitor cells, endothelial cells, adult cardiomyocytes, and smooth muscle cells. Cells can be of human origin (autologous or allogenic) or from an animal source (xenogenic), or genetically engineered.

Any of the therapeutic agents may be combined to the extent such combination is biologically compatible.

Any of the above mentioned therapeutic agents may be incorporated into a polymeric coating on the medical device or applied onto a polymeric coating on a medical device. With respect to the type of polymers that may be used in the coating according to the present invention, such polymers may be biodegradable or non-biodegradable. Non-limiting examples of suitable non-biodegradable polymers include polyvinylpyrrolidone including cross-linked polyvinylpyrrolidone; polyvinyl alcohols, copolymers of vinyl monomers such as EVA; polyvinyl ethers; polyvinyl aromatics; polyethylene oxides; polyesters including polyethylene terephthalate; polyamides; polyacrylamides; polyethers including polyether sulfone; polyalkylenes including polypropylene, polyethylene and high molecular weight polyethylene; polyurethanes; polycarbonates, silicones; siloxane polymers; polymer dispersions such as polyurethane dispersions (BAYHDROL®); squalene emulsions; and mixtures and copolymers of any of the foregoing.

Non-limiting examples of suitable biodegradable polymers include polycarboxylic acid, polyanhydrides including maleic anhydride polymers; polyorthoesters; poly-amino acids; polyethylene oxide; polyphosphazenes; polylactic acid, polyglycolic acid and copolymers and mixtures thereof such as poly(L-lactic acid) (PLLA), poly(D,L,-lactide), poly(lactic acid-co-glycolic acid), 50/50 (DL-lactide-co-glycolide); polydioxanone; polypropylene fumarate; polydepsipeptides; polycaprolactone and co-polymers and mixtures thereof such as poly(D,L-lactide-co-caprolactone) and polycaprolactone co-butylacrylate; polyhydroxybutyrate valerate and blends; polycarbonates such as tyrosine-derived polycarbonates and arylates, polyiminocarbonates, and polydimethyltrimethylcarbonates; cyanoacrylate; calcium phosphates; polyglycosaminoglycans; macromolecules such as polysaccharides (including hyaluronic acid; cellulosic polymers such as cellulose, cellulose acetate, and hydroxypropylmethyl cellulose; gelatin; starches; dextrans; alginates and derivatives thereof), proteins and polypeptides; and mixtures and copolymers of any of the foregoing. The biodegradable polymer may also be a surface erodable polymer such as polyhydroxybutyrate and its copolymers, polycaprolactone, polyanhydrides (both crystalline and amorphous), polyorthoesters, maleic anhydride copolymers, and zinc-calcium phosphate.

In a preferred embodiment, the polymer is polyacrylic acid available as HYDROPLUS® (Boston Scientific Corporation, Natick, Mass.), and described in U.S. Pat. No. 5,091,205, the disclosure of which is incorporated by reference herein. In a more preferred embodiment, the polymer is a co-polymer of polylactic acid and polycaprolactone.

Such coatings used with the present invention may be formed by any method known to one in the art. For example, an initial polymer/solvent mixture can be formed and then the therapeutic agent added to the polymer/solvent mixture. Alternatively, the polymer, solvent, and therapeutic agent can be added simultaneously to form the mixture. The polymer/solvent mixture may be a dispersion, suspension or a solution. The therapeutic agent may also be mixed with the polymer in the absence of a solvent. The therapeutic agent may be dissolved in the polymer/solvent mixture or in the polymer to be in a true solution with the mixture or polymer, dispersed into fine or micronized particles in the mixture or polymer, suspended in the mixture or polymer based on its solubility profile, or combined with micelle-forming compounds such as surfactants or adsorbed onto small carrier particles to create a suspension in the mixture or polymer. The coating may comprise multiple polymers and/or multiple therapeutic agents.

The coating can be applied to the medical device by any known method in the art including dipping, spraying, rolling, brushing, electrostatic plating or spinning, vapor deposition, air spraying including atomized spray coating, and spray coating using an ultrasonic nozzle.

The coating is typically from about 1 to about 50 microns thick. In the case of balloon catheters, the thickness is preferably from about 1 to about 10 microns, and more preferably from about 2 to about 5 microns. Very thin polymer coatings, such as about 0.2-0.3 microns and much thicker coatings, such as more than 10 microns, are also possible. It is also within the scope of the present invention to apply multiple layers of polymer coatings onto the medical device. Such multiple layers may contain the same or different therapeutic agents and/or the same or different polymers. Methods of choosing the type, thickness and other properties of the polymer and/or therapeutic agent to create different release kinetics are well known to one in the art.

The medical device may also contain a radio-opacifying agent within its structure to facilitate viewing the medical device during insertion and at any point while the device is implanted. Non-limiting examples of radio-opacifying agents are bismuth subcarbonate, bismuth oxychloride, bismuth trioxide, barium sulfate, tungsten, and mixtures thereof.

Non-limiting examples of medical devices according to the present invention include catheters, guide wires, balloons, filters (e.g., vena cava filters), stents, stent grafts, vascular grafts, intraluminal paving systems, implants and other devices used in connection with drug-loaded polymer coatings. Such medical devices may be implanted or otherwise utilized in body lumina and organs such as the coronary vasculature, esophagus, trachea, colon, biliary tract, urinary tract, prostate, brain, and the like.

While the present invention has been described in connection with the foregoing representative embodiment, it should be readily apparent to those of ordinary skill in the art that the representative embodiment is exemplary in nature and is not to be construed as limiting the scope of protection for the invention as set forth in the appended claims.

1. A method for coating at least a portion of at least one device, comprising:
arranging on a surface of a substrate a solution;
directing a beam at the substrate, the beam heating the substrate; and
arranging the at least one device in an ejection cone formed by a vaporization of the solution.

2. The method of claim 1, wherein the solution is vaporized by a heat transfer from the substrate to the solution.

3. The method of claim 1, wherein the ejection cone includes one of a vaporized solution and an atomized solution, the atomized solution being formed by an explosive vaporization of the solution.

4. The method of claim 1, wherein the solution includes a bioactive agent dissolved in a solvent, the solvent having a boiling point less than a thermal damage temperature of the bioactive agent.

5. The method of claim 4, further comprising ejecting by a vaporization of the solution at least a portion of the bioactive agent into the ejection cone.

6. The method of claim 4, wherein the bioactive agent includes at least one of a drug and a polymer.

7. The method of claim 4, further comprising, after the directing of the beam operation, directing a gas flow to transport the bioactive agent to the at least one device.

8. The method of claim 1, further comprising:
enclosing the substrate and the at least one device in an enclosure; and
removing by a pump the solvent in the vaporization of the solution from the enclosure.

10. The method of claim 8, wherein the enclosure is maintained at a partial vacuum.

11. The method of claim 1, wherein the arranging of the solution is by one of spraying and spin coating.

12. The method of claim 1, wherein the solution absorbs about zero energy of the beam.

13. The method of claim 1, wherein the substrate is one of flat, concave, and convex.

14. The method of claim 1, wherein the beam is one of a laser beam, an electron beam, and a light beam produced by a flashlamp.

15. The method of claim 1, wherein the beam is pulsed.

16. The method of claim 1, further comprising moving the beam with respect to the substrate.

17. The method of claim 1, further comprising moving the substrate with respect to the beam.

18. The method of claim 1, wherein the at least one device includes at least one medical appliance.

19. The method of claim 18, wherein the at least one medical appliance includes at least one stent.

20. The method of claim 1, further comprising:
arranging on the solution another solution, the other solution including a bioactive agent dissolved in a solvent; and
ejecting by the vaporization of the solution at least a portion of the other solution into the ejection cone.

21. The method of claim 20, wherein the arranging of other solution is by one of spraying and spin coating.

22. The method of claim 20, wherein the other solution absorbs about zero energy of the beam.

23. The method of claim 20, wherein:
the solvent of the other solution has a higher boiling point than a boiling point of the solution; and
the boiling point of the solution is less than a thermal damage temperature of the bioactive agent.

24. The method of claim 20, wherein the bioactive agent includes at least one of a drug and a polymer.

25. A system for coating at least one device, comprising:
a target assembly adapted to hold a substrate having a solution arranged on a surface of the substrate;
a beam source directed at the surface of the substrate and adapted to emit a beam; and
an arrangement adapted to hold the at least one device in an ejection cone, an apex of the ejection cone being at a target point that the beam contacts the surface.

26. The system of claim 25, wherein a vaporized agent is formed from the solution being vaporized by a heat transfer from the substrate to the solution.

27. The system of claim 26, wherein an atomized agent is formed by an explosive vaporization of the solution.

28. The system of claim 27, further comprising a gas source adapted to transport one of the vaporized agent and the atomized agent from the surface to the at least one device.

29. The system of claim 25, further comprising an evaporation chamber adapted to enclose at least the substrate and the at least one device.

30. The system of claim 29, further comprising a pump adapted to remove a solvent from the evaporation chamber, the pump forming a partial vacuum in the evaporation chamber.

31. The system of claim 25, wherein the beam source includes one of a laser, an electron beam source, and a flashlamp.

32. The system of claim 25, wherein the solution includes at least one of a drug and a polymer.

33. The system of claim 25, wherein the at least one device includes at least one medical appliance.

34. The system of claim 25, wherein one of the target assembly and the beam source is adapted to move with respect to the other of the target assembly and the beam source.

35. The system of claim 25, wherein the target assembly is adapted to spin, a spinning of the target assembly causing the solution to spread on the surface.

36. The system of claim 25, further comprising an arrangement for spraying the solution on the surface of the substrate.

37. A medical appliance having a coating applied by a method, the method comprising:
arranging on a surface of a substrate a solution;
directing a beam at the substrate, the beam heating the substrate; and
arranging the medical appliance in an ejection cone formed by a vaporization of the solution.

38. The medical appliance of claim 37, wherein the solution is vaporized by a heat transfer from the substrate to the solution.

39. The medical appliance of claim 37, wherein the ejection cone includes one of a vaporized solution and an atomized solution, the atomized solution being formed by an explosive vaporization of the solution.

40. The medical appliance of claim 37, wherein:
the solution includes a bioactive agent dissolved in a solvent, the solvent having a boiling point less than a thermal damage temperature of the bioactive agent; and
the vaporized solution ejects at least a portion of the bioactive agent into the ejection cone.

41. The medical appliance of claim 40, wherein the bioactive agent includes at least one of a drug and a polymer.

42. The medical appliance of claim 37, further comprising:
arranging on the solution another solution, the other solution including a bioactive agent dissolved in a solvent; and
ejecting by the vaporized solution at least a portion of the other solution into the ejection cone.

43. The medical appliance of claim 37, wherein the medical appliance includes a stent.

44. The medical appliance of claim 37, wherein the coating includes a masking material.

45. The medical appliance of claim 37, wherein the coating is chosen from a group consisting of a polymer with a suspended drug, a non-thrombogenic agent, a lubricious material, a non-slippery material, a radioactive agent, and a magnetic signature.

46. The medical appliance of claim 37, wherein the coating is a radiopaque agent.
